(19) United States
(12) Patent Application Publication
(10) Pub. No.: US 2012/0049651 A1
(43) Pub. Date: Mar. 1, 2012

(54) POWER SWITCH CONTROL DEVICE AND METHOD

(75) Inventors: XIANG YU, Shenzhen City (CN); DE-HUA DANG, Shenzhen City (CN); GE-XIN ZENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/978,415

(22) Filed: Dec. 24, 2010

(30) Foreign Application Priority Data
Aug. 24, 2010 (CN) 201010261281.8

(51) Int. Cl. H01H 3/00

(52) U.S. Cl. 307/116

(57) ABSTRACT

A power switch control device includes a control chip connected to power switches distributed in a room, and a microcontroller connected to the control chip. When a person gets through an entry/exit door of the room, both of a first sensor fixed to an interior surface of the door and a second sensor fixed to an exterior surface of the door sense the person. By comparing record times of the two sensors, the microcontroller can determine whether the person enters or exits the room. If the person enters the room and a count value is changed to one from zero, the microcontroller sends a power-on command to the control chip to switch the power switches on. If the person exits the room and the count value is changed to zero from one, the microcontroller sends a power-off command to the control chip to switch the power switches off.

### BACKGROUND

1. Technical Field

Embodiments of the present disclosure generally relate to control devices and methods, and more particularly to a device and method for controlling power switches to be switched on or off.

2. Description of Related Art

Currently, energy-saving and emission-reduction are advocated. For example, a person who is the last out of the office needs to turn off the lights and other devices. If the person forgets, much electricity can be wasted.

### BRIEF DESCRIPTION OF THE DRAWINGS

FIG. 1 is a schematic diagram of one embodiment of a power switch control device.

FIG. 2 is a block diagram of function modules of a microcontroller of the power switch control device in FIG. 1.

FIG. 3 is a flowchart illustrating one embodiment of a power switch control method.

### DETAILED DESCRIPTION

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

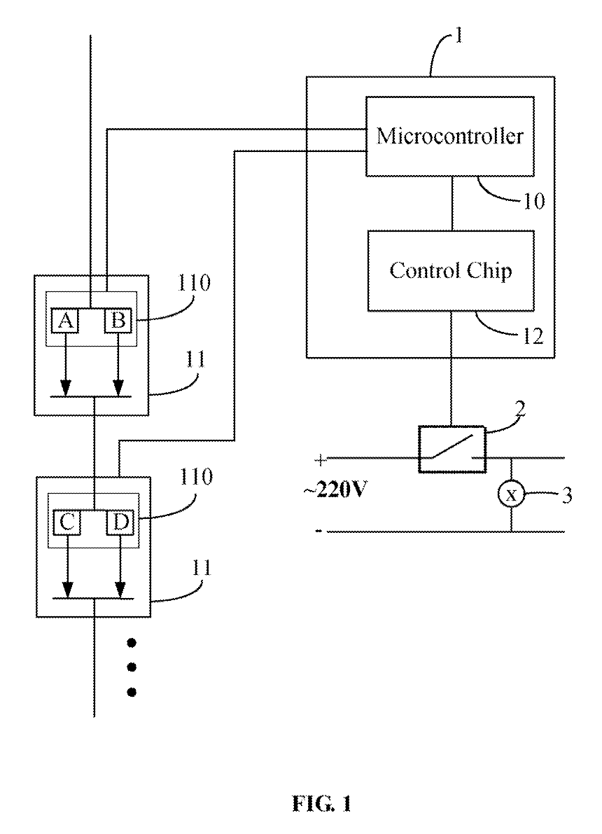

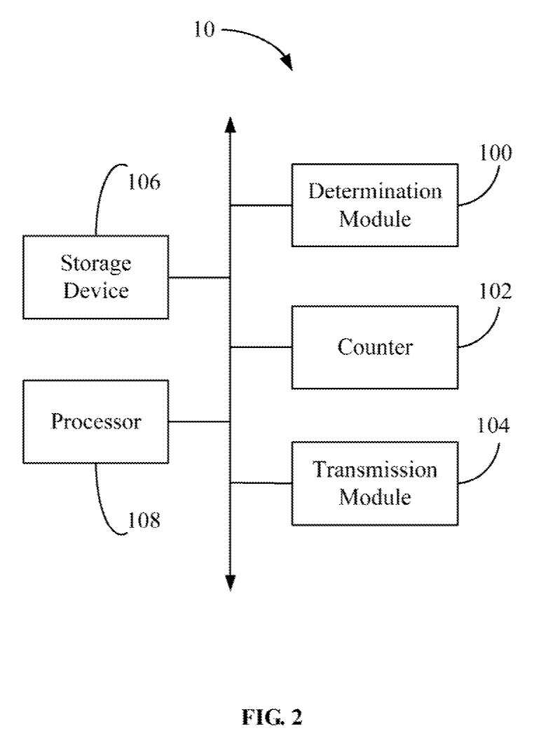

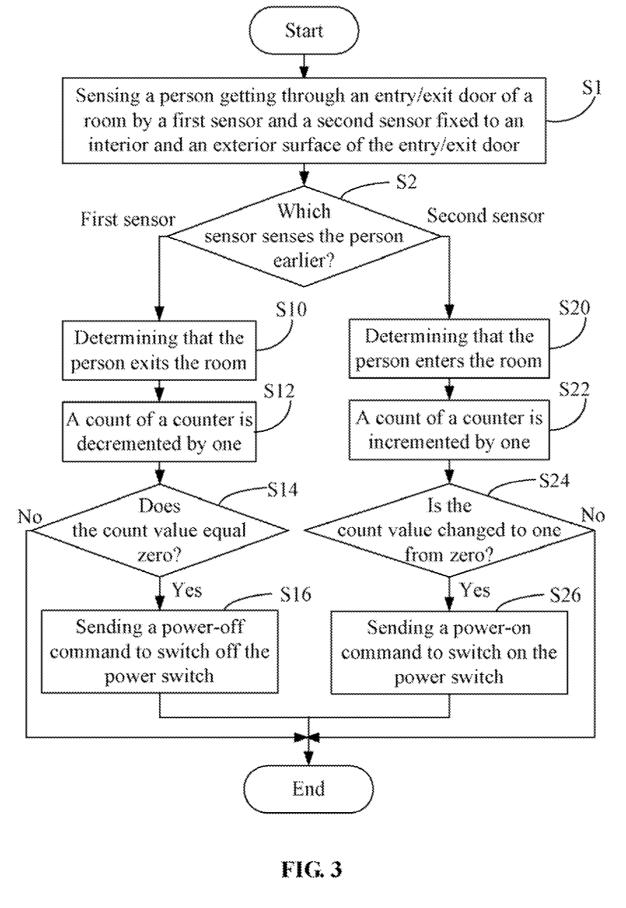

FIG. 1 is a schematic diagram of one embodiment of a power switch control device 1 (hereinafter referred to as “the control device 1”). In the embodiment, the control device 1 includes a microcontroller 10, and a control chip 12 connected to the microcontroller 10. Functions of the microcontroller 10 are described below in FIG. 2 and FIG. 3. The control chip 12 is connected to one or more power switches 2 (only one power switch 2 is shown in FIG. 1) distributed in a room, and each of the power switches 2 may be connected to at least one electronic device 3. One of the power switches 2 may be a power button, such as a computer keyboard button, or an electronic lamp button. The control chip 12 is used for controlling the at lest one electronic device 3 to turn on or turn off by switching the power switches 2 on or off. For example, if the electronic device 3 is an electric lamp, the control chip 12 can turn the electric lamp on or off through the corresponding power switch 2.

In the exemplary embodiment, the room has at least one entry/exit door 11 leading to an exterior of the room (two doors 11 are shown in FIG. 1). Two sensors 110 are respectively fixed to an interior surface and an exterior surface of each door 11. For example, first sensors A and C are respectively fixed on the interior surfaces of the doors 11, and second sensors B and D are respectively fixed to the exterior surfaces of the doors 11. In this embodiment, the sensors 110 are infrared sensors. It should be noted that in other embodiments any known sensor technology that detect passage or presence of humans may be employed.

The sensors 110, are configured to monitor an area near the door 11 where a user of the door 11 must pass through. As such, the sensors 110 can sense the body heat of any user passing through the doorway, and further, depending on the order the sensors 110 detect body heat can determine whether the person is entering or exiting the room.

FIG. 2 is a block diagram of function modules of the microcontroller 10 in FIG. 1. The microcontroller 10 may include one or more programs stored in a storage device 106, and executed by at least one processor 108. In one embodiment, the microcontroller 10 may include a determination module 100, a counter 102, and a transmission module 104.

Upon the condition that the first sensor (such as A or C) and the second sensor (such as B or D) senses a person gets through the door 11, a first record of the person is generated by the first sensor, and a second record of the person is generated by the second sensor. The determination module 100 obtains the first record and the second record, and determines whether the person enters or exits the room by comparing a record time of the first record with that of the second record.

In one example, if the second sensor senses the person before the first sensor, the determination module 100 determines that the person enters the room. In another embodiment, if the first sensor senses the person before the second sensor, the determination module 100 determines that the person exits the room.

Upon the condition that the person enters the room, a count of the counter 102 is incremented by one. If the count is changed to one from zero, the transmission module 104 may send a power-on command to the control chip 12 to switch the power switch 2 on, to turn on the electronic device 3.

Upon the condition that the person exits the room, the count of the counter 102 is decremented by one. If the count value is changed to zero from one, the transmission module 104 may send a power-off command to the control chip 12 to switch the power switch 2 off, to turn off the electronic device 3.

FIG. 3 is a flowchart illustrating one embodiment of a power switch control method by using the control device 1 of FIG. 1. In one embodiment, a first sensor is fixed inside of the door 11, and a second sensor is fixed outside of the door 11.

Once a person gets through the door 11, in block S01, the first sensor and the second sensor sense the person. When the person is sensed, the first sensor generates a first record of the person, and the second sensor generates a second record of the person.

In block S02, the determination module 100 obtains the first record and the second record, and determines which sensor senses the person earlier by comparing a record time of the first record with that of the second record, to determine whether the person enters or exits the room. If the first sensor senses the person before the second sensor, the flow goes to block S10. If the second sensor senses the person before the first sensor, the flow goes to block S20.

In block S10, the determination module 100 determines that the person exits the room. In block S12, a count of the counter 102 is decremented by one. In block S14, the counter 102 determines whether the count equals zero. If the count does not equal to zero, the flow ends. If the count equals zero, in block S16, the transmission module 104 sends a power-off command to the control chip 12 to switch off the power switch 2, to turn off the electronic device 3.

In block S20, the determination module 100 determines that the person enters the room. In block S22, the count of the counter 102 is incremented by one. In block S24, the counter 102 determines whether the count is changed to one from zero. That is, the counter 102 determines whether the count equals one. If the count is not changed to one from zero, the flow ends. If the count is changed to one from zero, in block S26, the transmission module 104 sends a power-on command to the control chip 12 to switch on the power switch 2, to turn on the electronic device 3.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A power switch control device, comprising:
a control chip being connected to one or more power switches distributed in a room; and
a microcontroller being connected to the control chip, the microcontroller comprising:
at least one processor;
a storage device; and
one or more programs stored in the storage device and executed by the at least one processor, the one or more programs comprising:
a determination module operable to obtain a first record of a person generated by a first sensor fixed to an interior surface of an entry/exit door of the room, and a second record of the person generated by a second sensor fixed to an exterior surface of the entry/exit door when the person gets through the entry/exit door, and determine whether the person enters or exits the room by comparing a record time of the first record with that of the second record;
a counter operable to increase a count by one upon the condition that the person enters the room, or decrease the count by one upon the condition that the person exits the room; and
a transmission module operable to send a power-on command to the control chip upon the condition that the count is changed to one from zero, or send a power-off command to the control chip upon the condition that the count is changed to zero from one; and
the control chip operable to switch on the power switches according to the power-on command, or switch off the power switches according to the power-off command.

2. The power switch control device as claimed in claim 1, wherein the determination module determines that the person enters the room upon the condition that the second sensor senses the person before the first sensor.

3. The power switch control device as claimed in claim 1, wherein the determination module determines that the person exits the room upon the condition that the first sensor senses the person before the second sensor.

4. The power switch control device as claimed in claim 1, wherein the first sensor and the second sensor are infrared sensors.

5. A power switch control method, the method comprising:
sensing a person getting through an entry/exit door of a room by a first sensor fixed to an interior surface of the entry/exit door and a second sensor fixed to an exterior surface of the entry/exit door;
generating a first record of the person by the first sensor, and generating a second record of the person by the second sensor;
determining whether the person enters or exits the room by comparing a record time of the first record with that of the second record;
upon the condition that the person enters the room, increasing a count of a counter by one and sending a power-on command to a control chip if the count is changed to one from zero; or
upon the condition that the person exits the room, decreasing the count by one and sending a power-off command to the control chip if the count is the changed to zero from one; and
switching on one or more power switches distributed in the room according to the power-on command; or
switching off the power switches according to the power-off command.

6. The power switch control method as claimed in claim 5, wherein the determining step comprises:
determining that the person enters the room upon the condition that the second sensor senses the person before the first sensor; or
determining that the person exits the room upon the condition that the first sensor senses the person before the second sensor.

7. The power switch control method as claimed in claim 5, wherein the first sensor and the second sensor are infrared sensors.

8. A storage medium having stored thereon instructions that, when executed by a processor of a control device, cause the control device to implement a method for controlling one or more power switches distributed in a room, the method comprising:
sensing a person getting through an entry/exit door of a room by a first sensor fixed to an interior surface of the entry/exit door and a second sensor fixed to an exterior surface of the entry/exit door;
generating a first record of the person by the first sensor, and generating a second record of the person by the second sensor;
determining whether the person enters or exits the room by comparing a record time of the first record with that of the second record;
upon the condition that the person enters the room, increasing a count of a counter by one and sending a power-on command to a control chip if the count is changed to one from zero; or
upon the condition that the person exits the room, decreasing the count by one and sending a power-off command to the control chip if the count is the changed to zero from one; and
switching on one or more power switches distributed in the room according to the power-on command; or
switching off the power switches according to the power-off command.

9. The storage medium as claimed in claim 8, wherein the determining step comprises:
determining that the person enters the room upon the condition that the second sensor senses the person before the first sensor; or
determining that the person exits the room upon the condition that the first sensor senses the person before the second sensor.

10. The storage medium as claimed in claim 8, wherein the first sensor and the second sensor are infrared sensors.
